(19) United States
(12) Patent Application Publication
(10) Pub. No.: US 2011/0212696 A1
(43) Pub. Date: Sep. 1, 2011

(54) System and Method for Reducing In-Band Interference for a Shared Antenna

(75) Inventors: Wilhelm Steffen Hahn, Los Altos, CA (US); Wei Chen, Newark, CA (US)

(73) Assignee: Intersil Americas Inc., Milpitas, CA (US)

(21) Appl. No.: 13/032,913

(22) Filed: Feb. 23, 2011

Related U.S. Application Data
(60) Provisional application No. 61/308,647, filed on Feb. 26, 2010.
(60) Provisional application No. 61/353,528, filed on Jun. 10, 2010.
(60) Provisional application No. 61/375,491, filed on Aug. 20, 2010.

(51) Int. Cl. H04B 1/44

(52) U.S. Cl. 455/83

(57) ABSTRACT

An interference compensation circuit for suppressing in-band or nearby out-of-band interference in a shared antenna communication system. The communication system can include a first communication device having a transmitter for transmitting signals within a first frequency band and a second communication device having a receiver for receiving electromagnetic signals within a second frequency band. The second frequency band can be adjacent or overlapping the first frequency band. The communication system also can include an interference compensation circuit that receives samples of the signals transmitted by the transmitter and generate an interference compensation signal in response to adjusting amplitude, phase, and/or delay of the samples. The interference compensation signal can suppress interference imposed on the receiver by the signals transmitted by the transmitter when applied to a signal receive path of the receiver.

### CROSS REFERENCE TO RELATED APPLICATIONS

This patent application claims to the benefit of U.S. Provisional Patent Application No. 61/308,647, entitled “System and Method for Reducing In-Band Interference for a Shared Antenna” and filed Feb. 26, 2010. This patent application also claims to the benefit of U.S. Provisional Patent Application No. 61/353,528, entitled “System and Method for Reducing In-Band Interference for a Shared Antenna,” filed Jun. 10, 2010. This patent application also claims to the benefit of U.S. Provisional Patent Application No. 61/375,491, entitled “Methods and Systems for Noise and Interference Cancellation” and filed Aug. 20, 2010. The entire contents of each of the foregoing priority applications are hereby incorporated herein by reference.

### BRIEF DESCRIPTION OF THE DRAWINGS

FIG. 1 is a functional block diagram of a communication system having a shared antenna and an interference compensation circuit, in accordance with certain exemplary embodiments.

FIG. 2 is a functional block diagram of a communication system having a shared antenna and an interference compensation circuit, in accordance with certain exemplary embodiments.

FIG. 3 is a functional block diagram of a communication system having a shared antenna and an interference compensation circuit, in accordance with certain exemplary embodiments.

FIG. 4 is a functional block diagram of a communication system having a multiple-input multiple output (“MIMO”) wireless local area network (“WLAN”) and a shared antenna, in accordance with certain exemplary embodiments.

FIG. 5 is a functional block diagram of a communication system having a MIMO WLAN and a shared antenna, in accordance with certain exemplary embodiments.

Many aspects of the invention can be better understood with reference to the above drawings. The drawings illustrate only exemplary embodiments of the invention and are therefore not to be considered limiting of its scope, as the invention may admit to other equally effective embodiments. The elements and features shown in the drawings are not necessarily to scale, emphasis instead being placed upon clearly illustrating the principles of exemplary embodiments of the present invention. Additionally, certain dimensions may be exaggerated to help visually convey such principles. In the drawings, reference numerals designate like or corresponding, but not necessarily identical, elements.

### DETAILED DESCRIPTION OF EXEMPLARY EMBODIMENTS

The present invention is directed to systems and methods for compensating for in-band and/or nearby out-of-band interference for a shared antenna communication system. Many mobile and non-mobile electronic devices include multiple communication devices that communicate using different protocols having overlapping or nearby frequency channels. For example, certain mobile telephones and laptop computers include both a wireless local area network (“WLAN”) transceiver operating at a frequency between 2.4 GHz and 2.5 GHz and a Bluetooth transceiver operating at a frequency between 2.4 GHz and 2.5 GHz. In another example, certain mobile telephones and laptop computers include both a WLAN transceiver and a Worldwide Interoperability for Microwave Access (WiMAX) transceiver operating at a frequency of approximately 2.5-2.7 GHz or around 2.3 GHz. In yet another example, certain mobile telephones and laptop computers include both a WiMAX transceiver and a Bluetooth transceiver. To reduce the size and amount of materials needed to manufacture devices having multiple communication devices or systems, it is advantageous for two or more of the communication devices to share a single antenna. However, when one communication device is actively transmitting at or close to the same frequency and at the same time that another communication device is receiving, the transmitting device can act as an interferer by introducing in-band or nearby out-of-band interference and/or noise onto the receive path of the receiving device. This interference and/or noise can degrade the sensitivity of the receiving device. The present invention provides systems and methods that allow multiple communication devices having overlapping or nearby frequencies to share a single antenna by reducing in-band and/or nearby out-of-band interference and/or noise that would otherwise degrade the sensitivity of the communications devices' receivers. Although the terms “noise” and “interference” are used interchangeably in this specification, the systems and methods discussed herein can support canceling, correcting, addressing, or compensating for interference, electromagnetic interference (“EMI”), noise, spurs, or other unwanted spectral components associated with communication devices sharing an antenna. In addition, the exemplary embodiments are described largely herein on a system level. However, the exemplary embodiments may be implemented as a system-on-chip (“SoC”) without departing from the scope and spirit of the present invention.

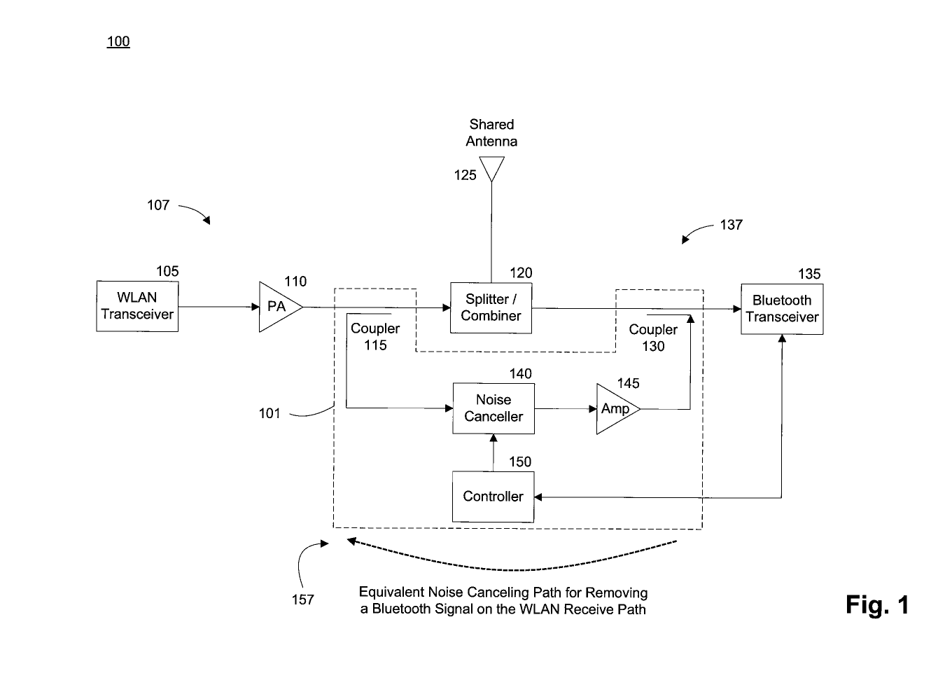

Turning now to the drawings, in which like numerals indicate like or corresponding (but not necessarily identical) elements throughout the figures, exemplary embodiments of the invention are described in detail. FIG. 1 is a functional block diagram of a communication system 100 having a shared antenna 125 and an interference compensation circuit 101, in accordance with certain exemplary embodiments. Referring to FIG. 1, the communication system 100 includes an antenna 125 that is shared by a WLAN transceiver 105 and a Bluetooth transceiver 135. For ease of illustration and subsequent description, FIG. 1 illustrates a WLAN transmit path 107 and a Bluetooth receive path 137 only. However, the WLAN transceiver 105 and the Bluetooth transceiver 135 are both capable of transmitting and receiving signals via the shared antenna 125. For the purpose of this disclosure, the term “transceiver” should be interpreted to include devices that have the capability to both transmit and receive signals, including devices having separate transmitters and receivers and devices having combined circuitry for transmitting and receiving signals.

The WLAN transmit path 107 and the Bluetooth receive path 137 include at least one transmission line, printed circuit board (“PCB”) trace, flex circuit trace, electrical conductor, waveguide, bus, or medium that provides a signal path. The WLAN transmit path 107 and the Bluetooth receive path 137 also can include active or passive circuit elements not illustrated in FIG. 1 including, but not limited to, a filter, switch, oscillator, diode, VCO, PLL, amplifier, and/or digital or mixed signal integrated circuit.

The WLAN transmit path 107 includes a power amplifier 110 for amplifying signals generated by the WLAN transceiver 105 prior to the signals being propagated by the shared antenna 125. The output of the power amplifier 110 is coupled to a signal splitter, a signal combiner, a (directional) coupler, a circulator, or other appropriate device or technology capable of managing the sharing of the shared antenna 125. For ease of subsequent discussion, this device or technology for managing the sharing of the shared antenna 125 is referred to herein as a splitter/combiner 120. The splitter/combiner 120 routes signals received by the shared antenna 125 to the transceivers 105 and 135. In addition, the splitter/combiner 120 routes signals transmitted by the transceivers 105 and 135 to the shared antenna 125.

In certain exemplary embodiments, the splitter/combiner 120 is the only separation between the WLAN transmit path 107 and the Bluetooth receive path 137. Similarly, in certain exemplary embodiments, the splitter/combiner 120 is the only separation between a Bluetooth transmit path and a WLAN receive path. This limited isolation between transmit and receive paths for transceivers operating at overlapping or nearby channels can degrade the sensitivity of the receiving transceiver. For example, a signal transmitted by the WLAN transceiver 105 can introduce in-band and/or nearby out-of-band interference and/or noise onto the Bluetooth receive path 137 and thus degrade the ability of the Bluetooth transceiver 135 to detect a Bluetooth signal. In certain exemplary embodiments, signals transmitted by the WLAN transceiver 105 may be as strong as +12 dBm (or stronger) at or on the Bluetooth receive path 137.

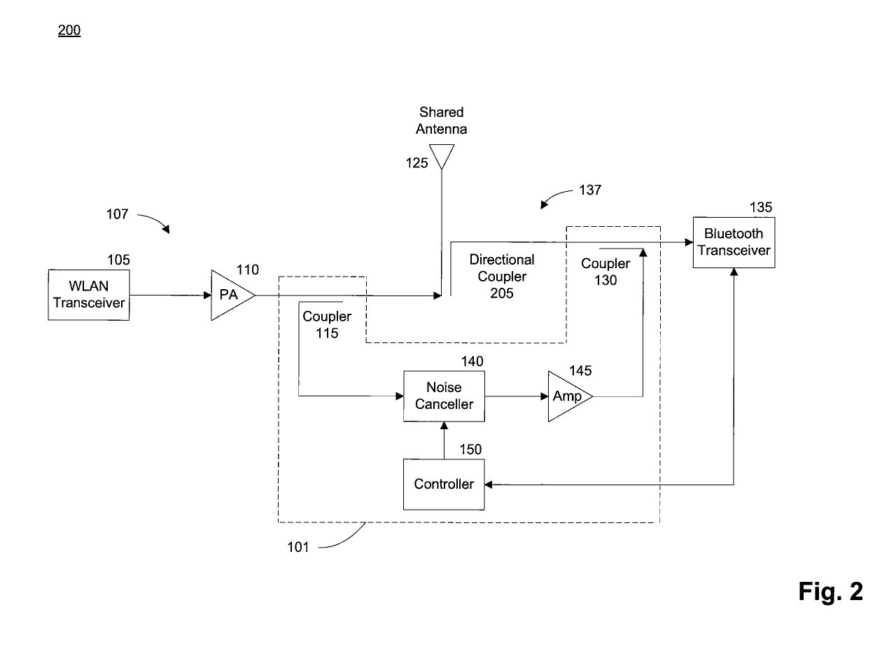

In certain exemplary embodiments, the splitter/combiner 120 may be replaced with a directional coupler. For example, FIG. 2 is a functional block diagram of an alternative communication system 200 having a shared antenna 125 and an interference compensation circuit 101, in accordance with certain exemplary embodiments. Referring to FIG. 2, the communication system 200 includes a directional coupler 205 in place of the splitter/combiner 120 of the communication system 100. The directivity of the directional coupler 205 provides increased isolation between the WLAN transmit path 107 and the Bluetooth receive path 137. However, the coupling factor of the directional coupler 205 may decrease the sensitivity of a receiver, such as a Bluetooth receiver, as well as reduce the output power of the Bluetooth transmitter at the shared antenna 125.

Referring back to FIG. 1, the interference compensation circuit 101 includes a noise canceller 140 for compensating for in-band and/or nearby out-of-band interference introduced onto the Bluetooth receive path 137 by signals transmitted along the WLAN transmit path 107. The input of the noise canceller 140 is coupled to the WLAN transmit path 107 between the power amplifier 110 and the splitter/combiner 120 by way of a coupler 115 and one or more electrical conductors. The coupler 115 obtains samples of signals transmitted by the WLAN transceiver 105 and provides the samples to the noise canceller 140. From this position, the coupler 115 can obtain a sample or a representation of the interference or of the aggressor signal transmitted by the WLAN transceiver 105, which produces, induces, generates, or otherwise causes the interference. In certain exemplary embodiments, the coupler 115 provides a direct connection to the transmit path 107. Alternatively, a capacitor, resistor, antenna, or other device could be used in place of or in addition to the coupler 115 to obtain samples of the signals transmitted by the WLAN transmit path 107.

The noise canceller 140 adjusts the amplitude, phase, and/or delay of the sampled signals to produce an interference compensation signal that, when applied to the receive path 137 of the Bluetooth transceiver 135, reduces, suppresses, or cancels the amplitude of in-band and/or nearby out-of-band interference and/or noise introduced onto the Bluetooth receive path 137 by signals transmitted along the WLAN transmit path 107. In certain exemplary embodiments, the noise canceller 140 adjusts the phase, amplitude, and/or delay of the sampled signals to produce an interference compensation signal having a 180 degree or approximately 180 degree phase shift relative to that of the in-band interference and/or noise and an amplitude close to that of the in-band interference and/or noise. In certain exemplary embodiments, the noise canceller 140 adjusts the amplitude, phase, and/or delay of the sampled signals based on settings received from another device, such as a controller 150 discussed below. These settings can include an in-phase setting (“I-value”) and a quadrature setting (“Q-value”).

One or more amplifiers 145 are coupled to the output of the noise canceller 140 to provide compensation for coupler loss and attenuation in the path of the noise canceller 140. This amplified interference compensation signal is coupled to the Bluetooth receive path 137 by way of a coupler 130. In certain exemplary embodiments, the coupler 130 is a directional coupler to avoid the amplified interference compensation signal being returned to the WLAN transmit path 107 and to mix with the original signal transmitted by the WLAN transceiver 105. Mixing the interference compensation signal with the original transmitted WLAN signal can cause signal integrity degradation. For example, in an 802.11g WLAN embodiment, the mixing of the interference compensation signal with the original transmitted WLAN signal can degrade orthogonal frequency division multiplexing (“OFDM”) modulation of the original transmitted WLAN signal and hence limit the achievable data rate.

In certain exemplary embodiments, an attenuator is positioned between the coupler 115 and the noise canceller 140 based on linearity considerations of the noise canceller 140. This attenuator can reduce the power level of a signal sampled from the WLAN transmit path 107 to a power level appropriate for the noise canceller 140. In addition or in the alternative, the coupler 115 has a low coupling coefficient. In certain exemplary embodiments, signals transmitted by the WLAN transceiver 105 are sampled at the input of the power amplifier 110 or at a point further upstream from the input of the power amplifier 110 (e.g., a pre-driver input).

The communication system 100 also can include a controller 150, such as a microcontroller, a microprocessor, computer, state machine, or other programmable device. The controller can be coupled to the WLAN transceiver 105, the Bluetooth transceiver 135, and to the noise canceller 140. The controller 150 executes one or more algorithms and/or include control logic for optimizing the reduction of noise by the noise canceller 140. Exemplary algorithms that may be implemented by the controller 150 in certain exemplary embodiments described herein are discussed in U.S. patent application Ser. No. 13/014,681, entitled, “Methods and Systems for Noise and Interference Cancellation,” and filed on Jan. 26, 2011. The entire contents of U.S. patent application Ser. No. 13/014,681 are hereby fully incorporated herein by reference. The algorithms executed by the controller 150 can include one or more of a binary correction algorithm (“BCA”), a fast binary algorithm (“FBA”), a minstep algorithm (“MSA”), a blind shot algorithm (“BSA”), a dual slope algorithm (“DSA”), and a track and search algorithm described in U.S. patent application Ser. No. 13/014,681.

One exemplary function of the controller 150 is to adjust the settings (e.g., I-value and Q-value) of the noise canceller 140 in order to improve the reduction of in-band and/or nearby out-of-band interference affecting the sensitivity of the Bluetooth transceiver 135. In particular, the controller 150 adjusts the settings of the noise canceller 140 to adjust the amplitude, phase, and/or delay of the signal output by the noise canceller 140. The controller 150 interacts with the Bluetooth transceiver 135 to monitor a feedback value that indicates a level of interference or a level of interference compensation achieved by the interference compensation signal. In certain exemplary embodiments, this feedback value includes one or more of a Signal to Noise Ratio (“SNR”), a Receive Signal Strength Indicator (“RSSI”), a Repeater Amplifier Gain, a Carrier to Noise Ratio (“C/N”), a Packet Error Rate (“PER”), a Bit Error Rate (“BER”), and an Error Vector Magnitude. Typically, the polarity of the feedback value is positive (the higher the better) if SNR, or C/N, or Repeater Amplifier Gain is used as the feedback value. Typically, the polarity of the feedback value is negative (the lower the better) if others of the aforementioned feedback values not having a positive feedback polarity are used.

The controller 150 uses the feedback value to selectively adjust the settings of the noise canceller 140 based on one or more algorithms (e.g., BCA, FBA, MSA, BSA, DSA, or track and search) stored on the controller 150 (or an external memory device) for lowest bit error rate for each WLAN channel affecting the Bluetooth transceiver 135. In certain exemplary embodiments, the controller 150 initially instructs the noise canceller 140 to use pre-stored settings and adjust the settings as appropriate. In certain exemplary embodiments, the controller 150 is communicably coupled to a power detector that measures the power level of the interference and uses this power measurement to adjust the settings of the noise canceller 140. The preferred settings can then be stored in a memory storage device coupled to the controller 150, such as RAM, ROM, flash memory, removable media, hard disk, memory stick, optical media, etc.

The controller 150 also interacts with auxiliary circuits to monitor characteristics of a device in which the communication system 100 is installed. In one example, the controller 150 monitors the temperature inside a mobile device or an external temperature outside of the mobile device. In another example, the controller 150 monitors the mobile device's power supply. The controller 150 can use these characteristics to find preferred interference and/or noise cancellation points (e.g., a preferred I-vale and a preferred Q-value) in real time for each interfering channel of signals transmitted by the WLAN transmit path 107 and/or signals transmitted by the Bluetooth transceiver 135.

In certain exemplary embodiments, the communication system 100 includes a transmit/receive (“T/R”) switch disposed between each transceiver 105, 135 and the splitter/combiner 120. The T/R switches switch between transmit and receive modes for the corresponding transceiver 105, 135. In certain exemplary embodiments, a T/R switch for the WLAN transmit path 107 is disposed between the power amplifier 110 and the splitter/combiner 120. In such an embodiment, the sampling point (i.e., location of the coupler 115) may be positioned between the power amplifier 110 and the T/R switch. Similarly, in certain exemplary embodiments, a T/R switch for the Bluetooth receive path 137 is disposed between the splitter/combiner 120 and the Bluetooth transceiver 135. The point at which the interference compensation signal is applied to the Bluetooth transceiver 135 is along the receive path between this T/R switch and the Bluetooth transceiver 135. Similar arrangements of T/R switches also can be applied to a Bluetooth transmit path and a WLAN receive path.

The communication system 100 described above allows a device to properly communicate via a WLAN transceiver and a Bluetooth transceiver simultaneously with a shared antenna. Certain exemplary embodiments of the communication system 100 provide more than 30 dBc cancellation of interference and/or noise for a Bluetooth receiver at 2.4-2.5 GHz caused by a WLAN transceiver acting as an interferer at a power level of +5 dBm.

As illustrated in FIG. 1 by dashed arrow 157, certain exemplary embodiments of the communication system 100 include substantially the same or a similar interference compensation circuit as the interference compensation circuit 101 that compensates for interference imposed on a WLAN receive path by signals generated by the Bluetooth transceiver 135. That is, a second noise canceller obtains a sample of signal transmitted along a Bluetooth transmit path (e.g., via coupler 130 or another coupler) and processes the sample to produce an interference compensation signal that, when applied to a WLAN receive path (e.g., via coupler 115 or another coupler), reduces in-band and/or nearby out-of-band interference imposed on the WLAN receive path by signals transmitted by the Bluetooth transceiver 135. The noise canceller for this interference compensation circuit can be substantially the same as or similar to that of the noise canceller 140 described above and be communicably coupled to the controller 150 to receive preferred settings (e.g., a preferred I-value and a preferred Q-value). These preferred settings can be determined using one of the algorithms (e.g., BCA, FBA, MSA, BSA, DSA, or track and search) described in U.S. patent application Ser. No. 13/014,681.

In certain exemplary embodiments, the noise canceller 140 and the amplifier 145 are connected between two switches in such a way that they are reversed synchronously with transmit and receive operations of the two transceivers 105 and 135. Thus, the cost of the communication system 100 can be reduced by eliminating a noise canceller and an amplifier, while adding two switches.

The communication system 100 is especially useful for mobile devices, such as mobile telephones, laptop computers, notebook computers, handheld computers, netbook computers, tablet computers, personal digital assistants (“PDAs”), WiMAX devices, and LTE devices. Although the communication system 100 is described above in terms of WLAN and Bluetooth, the present invention can be applied to improve isolation between or among other types of communication devices or systems sharing the same antenna, having overlapping or nearby channels, and/or having capabilities for communicating using both communication devices or systems simultaneously.

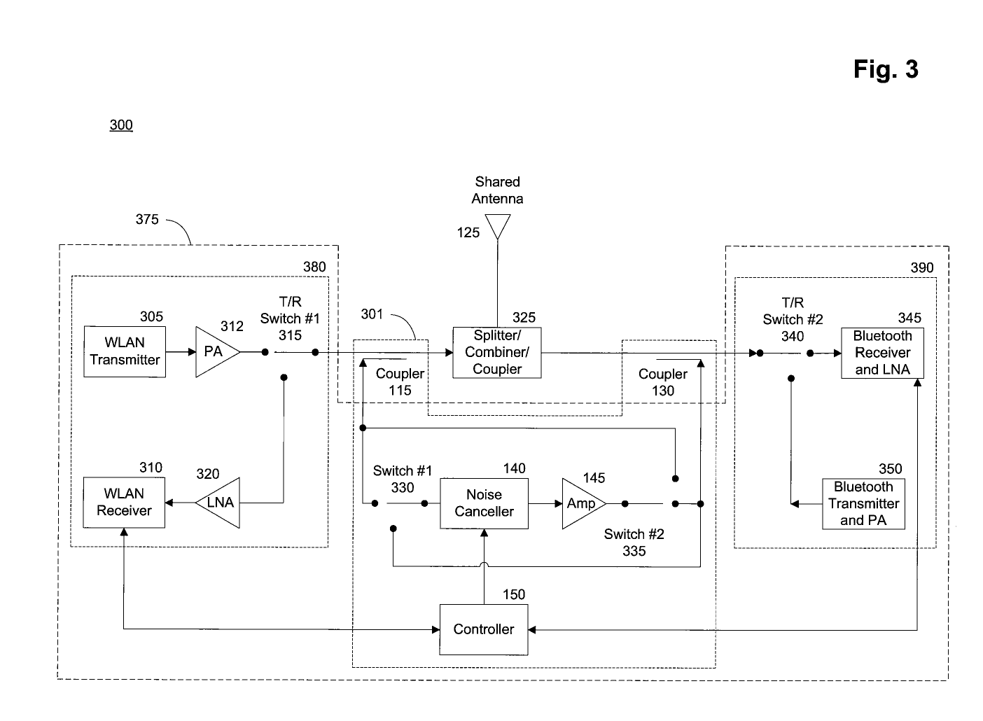

FIG. 3 is a functional block diagram of a communication system 300 having a shared antenna 125 and an interference compensation circuit 301, in accordance with certain exemplary embodiments. The system 300 is an alternative embodiment to the communication system 100 illustrated in FIG. 1. Referring to FIG. 3, the communication system 300 includes a WLAN transceiver 380 that includes a WLAN transmitter 305, a WLAN receiver 310, a power amplifier 312, a low noise amplifier (“LNA”) 320, and a T/R switch 315. The communication system 300 also includes a Bluetooth transceiver 390 that includes a Bluetooth transmitter 350, a Bluetooth receiver 345, and a T/R switch 340. The Bluetooth transceiver 390 also includes a power amplifier disposed along the communication path of the Bluetooth transmitter 350 and an LNA disposed along the communication path of the Bluetooth receiver 345. The T/R switches 315 and 340 provide time domain transmit and receive switching for the WLAN transceiver 380 and the Bluetooth transceiver 390, respectively. The communication system 300 also includes a signal splitter, signal combiner, or coupler (“splitter/combiner/coupler”) 325 that manages the sharing of the shared antenna 125.

The communication system 300 also includes a noise canceller 140 that can be the same or similar to the noise canceller 140 of the communication system 100. In this exemplary embodiment, the noise canceller 140 reduces interference for two directions of communication. In particular, the noise canceller 140 protects the Bluetooth receiver 345 from interference imposed on the Bluetooth receiver 345 by the WLAN transmitter 305. The noise canceller 140 also protects the WLAN receiver 310 from interference imposed on the WLAN receiver 310 by the Bluetooth transmitter 350.

The communication system 300 includes switches 330, 335 that are used to select between the two directions of protection. In particular, with the switches 330, 335 positioned as illustrated in FIG. 3, the noise canceller 140 protects the Bluetooth receiver 345 from interference imposed on the Bluetooth receiver 345 by the WLAN transmitter 305. If both switches 330 and 335 are toggled to their alternative positions, the noise canceller 140 protects the WLAN receiver 310 from interference imposed on the WLAN receiver 310 by the Bluetooth transmitter 350.

As illustrated in FIG. 3, when the T/R switch 315 is set for signal transmission (i.e., WLAN transmission) and the T/R switch 340 is set for signal reception (i.e., Bluetooth reception), switch 330 is set to connect the input of noise canceller 140 to directional coupler 115 for obtaining samples of signals output by the WLAN power amplifier 312. The samples are passed to the noise canceller 140 and amplifier 145 for amplitude, phase, and/or delay adjustment. In this configuration, switch 335 is positioned to connect the output of the amplifier 145 to directional coupler 130 so that the adjusted signal is passed to the Bluetooth receiver 345 via the coupler 130 and the T/R switch 340. The noise canceller 140 can adjust the phase, amplitude, and/or delay of the samples to produce an interference compensation signal that, when applied to the receive path of the Bluetooth receiver 345, cancels or reduces interference imposed on the Bluetooth receiver 345 by the WLAN transmitter 305. For example, the noise canceller 140 can produce an interference compensation signal to cancel or reduce interference caused by signals leaked by the WLAN power amplifier 312 and received by the Bluetooth receiver 345 via splitter/combiner/coupler 325.

In certain exemplary embodiments, the noise canceller 140 is communicably coupled to a controller 150 that adjusts the I-value and Q-value of the noise canceller 140 based on one or more algorithms (e.g., BCA, FBA, MSA, BSA, DSA, or track and search) and the intensity level of the interference as detected by a power detector or a feedback value (e.g., SNR, RSSI, Repeater Amplifier Gain, C/N, PER, BER, or an Error Vector Magnitude) received from the Bluetooth receiver 345. The controller 150 may also selectively activate and deactivate the canceller 140. For example, the controller 150 may deactivate the canceller 140 and/or the amplifier 145 when both transceivers 380 and 390 are either in receive mode or in transmit mode simultaneously.

When the T/R switch 340 is set for signal transmission (i.e., Bluetooth transmission) and the T/R switch 315 is set for signal reception (i.e., WLAN reception), the switch 330 connects the input of the noise canceller 140 to directional coupler 130 for receiving samples of signals output by the Bluetooth transmitter 350 (e.g., at the output of the Bluetooth power amplifier). These samples are passed to the noise canceller 140 and the amplifier 145 for amplitude, phase, and or delay adjustment. In this configuration, switch 335 is positioned to connect the output of the amplifier 145 to directional coupler 115 so that the adjusted signal is passed to the WLAN receiver 310 via the coupler 115 and the T/R switch 315. The noise canceller 140 can adjust the phase, amplitude, and/or delay of the samples to produce an interference compensation signal that, when applied to the receive path of the WLAN receiver 310, cancels or reduces interference imposed on the WLAN receiver 310 by signals transmitted by the Bluetooth transmitter 350. For example, the noise canceller 140 can produce an interference compensation signal to cancel or reduce interference caused by signals leaked by the Bluetooth transmitter 350 and received by the WLAN receiver 310 via splitter/combiner/coupler 325. In certain exemplary embodiments, the controller 150 adjusts the I-value and Q-value of the noise canceller 140 for this direction of communication based on one or more algorithms (e.g., BCA, FBA, MSA, BSA, DSA, or track and search) and the intensity level of the interference as detected by a power detector or a feedback value (e.g., SNR, RSSI, Repeater Amplifier Gain, C/N, PER, BER, or an Error Vector Magnitude) received from the WLAN receiver 310.

As illustrated by chip boundary 375, in certain exemplary embodiments, the noise canceller 140 and amplifier 145 are integrated with the WLAN transceiver 380 and the Bluetooth transceiver 390. For example, all or a portion of the components of the WLAN transceiver 380 and the Bluetooth transceiver 390 can be fabricated on a single integrated circuit with the noise canceller 140 and amplifier 145. Alternatively, the components of the WLAN transceiver 380, the Bluetooth transceiver 390, and the interference compensation circuit 301 can be fabricated on multiple integrated circuits.

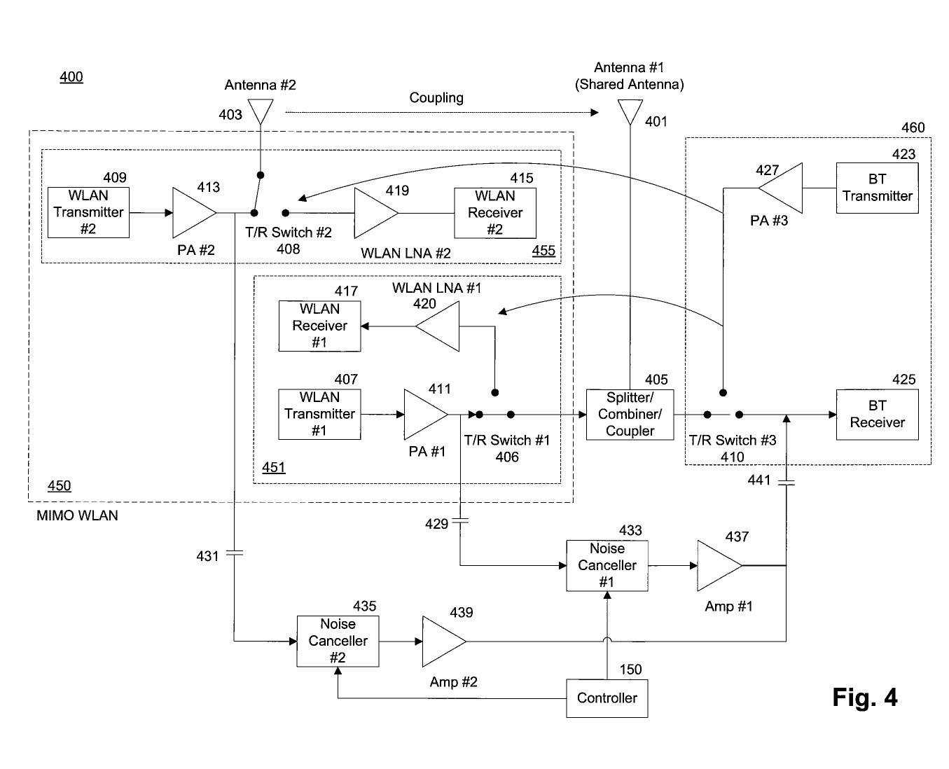

FIG. 4 is a functional block diagram of a communication system 400 having a multiple-input multiple output (“MIMO”) WLAN 450 and a shared antenna 401, in accordance with certain exemplary embodiments. Referring to FIG. 4, the communication system 400 includes a 2×2 MIMO WLAN 450 having two communication paths. A first communication path includes a first WLAN transceiver 451 electrically coupled to a first antenna 401 via one or more electrical conductors and a splitter/combiner/coupler 405. The first WLAN transceiver 451 includes a WLAN transmitter 407 that transmits communication signals via the first antenna 401 and a WLAN receiver 417 that receives communication signal via the first antenna 401. The first WLAN transceiver 451 also includes a power amplifier 411 for amplifying signals transmitted by the WLAN transmitter 407 and an LNA for amplifying signals received by the WLAN receiver 417. The first WLAN transceiver 451 also includes a T/R switch 406 that selectively connects either the WLAN transmitter 407 or the WLAN receiver 417 to the splitter/combiner/coupler 405. That is, the T/R switch 406 connects the WLAN transmitter 407 to the first antenna 401 via the splitter/combiner/coupler 405 when the first WLAN transceiver 451 is in transmit mode of operation, while connecting the WLAN receiver 417 to the first antenna 401 via the splitter/combiner/coupler 405 when the first WLAN transceiver 451 is in a receive mode of operation.

Similarly, the second WLAN transceiver 455 includes a WLAN transmitter 409, a power amplifier 413, a WLAN receiver 415, an LNA 419, and a T/R switch 408. The T/R switch 408 connects the WLAN transmitter 409 to the second antenna 403 when the second WLAN transceiver 455 is in a transmit mode of operation, while connecting the WLAN receiver 415 to the second antenna 403 when the second WLAN transceiver 455 is in a receive mode of operation.

The exemplary communication system 400 includes a Bluetooth transceiver 460 that shares the first antenna 401 with the first WLAN transceiver 451. The splitter/combiner/coupler 405 manages this sharing of the first antenna 401. The Bluetooth transceiver 460 includes a Bluetooth transmitter 423 that is electrically coupled to the splitter/combiner/coupler 405 via one or more electrical conductors and a power amplifier 427 that amplifies signals transmitted by the Bluetooth transmitter 423. The Bluetooth transceiver 460 also includes a Bluetooth receiver 425 that receives communication signals via the first antenna 401 and the splitter/combiner/coupler 405. The Bluetooth transceiver 460 also includes a T/R switch 410 that connects the Bluetooth transmitter 423 to the first antenna 401 via the splitter/combiner/coupler 405 when the Bluetooth transceiver 460 is in a transmit mode of operation, while connecting the Bluetooth receiver 425 to the first antenna 401 via the splitter/combiner/coupler 405 when the Bluetooth transceiver 460 is in a receive mode of operation.

The exemplary communication system 400 also includes a first sampling capacitor 429 that connects the output of the power amplifier 411 to a first noise canceller 433. The exemplary first noise canceller 433 can be the same or substantially similar to the noise canceller 140 illustrated in FIG. 1 and discussed above. In this exemplary embodiment, when the first WLAN transceiver 451 (and thus, the power amplifier 411) is in a transmit mode of operation, the first sampling capacitor 429 obtains samples of signals transmitted by the WLAN transmitter 407 and passes the samples to the first noise canceller 433. The first noise canceller 433, along with an amplifier 437 coupled to the output of the first noise canceller 433, adjusts at least one of amplitude, phase, and delay of the samples to produce an interference compensation signal that, when applied to the signal path of the Bluetooth receiver 425, cancels, suppresses, or reduces interference imposed on the Bluetooth receiver 425 by the signals transmitted by the WLAN transmitter 407. In one example, the first noise canceller 433 produces an interference compensation signal that cancels or reduces interference leaked from the power amplifier 411 through the splitter/combiner/coupler 405 onto the signal path of the Bluetooth receiver 425. In this exemplary embodiment, the communication system 400 includes a coupling capacitor 441 connected between the output of the amplifier 437 and the signal path of the receiver 425 for coupling the interference compensation signal to the signal path of the receiver 425.

The exemplary communication system 400 also includes a second noise canceller 435 (and associated amplifier 439) electrically coupled between the output of the power amplifier 413 and the signal path of the Bluetooth receiver 425 via one or more electrical conductors, a second sampling capacitor 431, and the coupling capacitor 441. When the second WLAN transceiver 455 (and thus, the power amplifier 413) is in a transmit mode of operation, the second sampling capacitor 431 obtains samples of signals transmitted by the WLAN transmitter 409 and passes the samples to the second noise canceller 435. The second noise canceller 435, along with the amplifier 439 coupled to the output of the second noise canceller 435, adjusts at least one of amplitude, phase, and delay of the samples to produce an interference compensation signal that, when applied to the signal path of the Bluetooth receiver 425, cancels suppresses, or reduces interference imposed on the Bluetooth receiver 425 by the signals transmitted by the WLAN transmitter 409. In one example, the second noise canceller 435 produces an interference compensation signal that cancels or reduces interference coupled to the signal path of the Bluetooth receiver 425 via coupling between the second antenna 403 and the first antenna 401. Similar to the interference compensation signal produced by the first noise canceller 433, the interference compensation signal produced by the second noise canceller 435 (and amplifier 439) is coupled to the signal path of the Bluetooth receiver 425 via the coupling capacitor 441.

In the illustrated embodiment, the interference compensation signals produced by the noise cancellers 433 and 435 (and their respective amplifiers 437 and 439) are combined at the input of the coupling capacitor 441. In alternative exemplary embodiments, each noise canceller 433, 435 can be coupled to the signal path of the Bluetooth receiver 425 via a dedicated coupling capacitor. That is, the communication system 400 can include a first coupling capacitor connected between the output of the amplifier 437 and the signal path of the Bluetooth receiver 425 and a second coupling capacitor connected between the output of the amplifier 439 and the signal path of the Bluetooth receiver 425.

The exemplary communication system 400 also includes a controller 150 communicably coupled to the noise cancellers 433, 435. In certain exemplary embodiments, the controller 150 is also communicably coupled to one or more of the receivers 415, 417, 425 to receive a feedback value (e.g., SNR, RSSI, Repeater Amplifier Gain, C/N, PER, BER, or an Error Vector Magnitude) indicative of a level of imposed interference or indicative of a level of interference compensation. The controller 150 executes one or more algorithms (e.g., BCA, FBA, MSA, BSA, DSA, or track and search) using the feedback value or a power measurement of the interference to determine preferred settings (e.g., I-value and Q-values) for the noise cancellers 433, 435.

Although the communication system 400 has been described in terms of compensating for interference imposed onto a Bluetooth receive signal path by signals transmitted by WLAN transmitters, a similar interference compensation method and system can be employed to compensate for interference imposed on one or both WLAN receive signal paths by signals transmitted by a Bluetooth transmitter. Furthermore, the interference compensation methods and systems described in connection with FIG. 4 can be used with other types of communication devices and systems as would be appreciated by one of ordinary skill in the art having the benefit of the present disclosure.

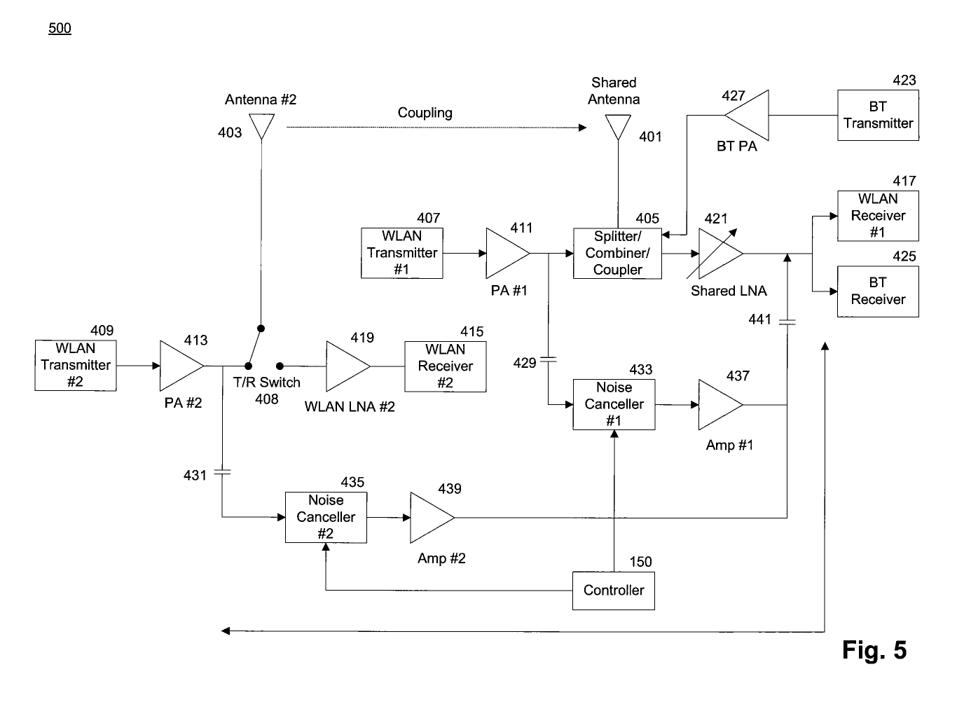

FIG. 5 is a functional block diagram of a communication system 500 having a MIMO WLAN and a shared antenna 401, in accordance with certain exemplary embodiments. The communication system 500 is an alternative embodiment of the communication system 400 illustrated in FIG. 4. Referring to FIG. 5, the exemplary communication system 500 differs from the communication system 400 in that the WLAN receiver 417 and the Bluetooth receiver 425 share an LNA 421. The LNA 421 amplifies signals received by the first (shared) antenna 401 prior to the received signals being passed to either the WLAN receiver 417 or the Bluetooth receiver 425.

Although the communications systems 400 and 500 are illustrated having a 2×2 MIMO WLAN sharing an antenna 401 with a Bluetooth transceiver 460, a similar method and system can be applied to communication systems having, for example, a 3×3 or 4×4 MIMO WLAN sharing one or more antennas with a Bluetooth or WiMAX transceiver.

The exemplary communication systems 100-500 illustrated in FIGS. 1-5 and discussed above also can include multiple noise cancellers, such as noise canceller 140 in parallel to increase the interference compensation bandwidth. When using multiple noise cancellers in parallel, one or more algorithms illustrated in FIGS. 29-31 of U.S. patent application Ser. No. 13/014,681 could be executed by the controller 150 to determine the preferred settings for each of the noise cancellers.

The communication systems 100-500 illustrated in FIGS. 1-5 are largely described above in terms of WLAN and Bluetooth. However, the present invention can be applied to improve isolation between or among other types of communication devices or systems sharing the same antenna, having overlapping or nearby channels, and/or having capabilities for communicating using both communication devices or systems simultaneously. For example, the interference compensation circuits illustrated in FIGS. 1-5 and discussed above can be used to improve isolation between communication devices sharing an antenna in Code Division Multiple Access (“CDMA”), Global System for Mobile Communications (“GSM”), Industrial, Scientific, and Medical (“ISM”), Long Term Evolution (“LTE”), WiMAX, and many other applications. For example, one or more embodiments of the present invention can be used to improve interference isolation between an LTE device or module and a WiMAX device or module sharing an antenna of a mobile telephone. In another example, one or more embodiments of the present invention can be used to improve interference isolation between a CDMA or GSM device or module and an ISM device or module sharing an antenna of a mobile telephone or device.

Although specific embodiments of the invention have been described above in detail, the description is merely for purposes of illustration. It should be appreciated, therefore, that many aspects of the invention were described above by way of example only and are not intended as required or essential elements of the invention unless explicitly stated otherwise. Various modifications of, and equivalent steps corresponding to, the disclosed aspects of the exemplary embodiments, in addition to those described above, can be made by a person of ordinary skill in the art, having the benefit of the present disclosure, without departing from the spirit and scope of the invention defined in the following claim(s), the scope of which is to be accorded the broadest interpretation so as to encompass such modifications and equivalent structures.

What is claimed is:

1. A communication system, comprising:
a first communication device comprising a first transmitter for transmitting signals comprising a frequency within a first frequency band via a shared antenna;
a second communication device comprising a first receiver for receiving signals comprising a frequency within a second frequency band via the shared antenna, the second frequency band being adjacent or overlapping the first frequency band;
a first input for obtaining first samples of the signals transmitted by the first transmitter;
a first output for coupling a first interference compensation signal to a receive path of the first receiver; and
a first interference compensation circuit, disposed between the first input and the first output, that adjusts at least one of amplitude, phase, and delay of the first samples based on an in-phase parameter and a quadrature parameter to generate the first interference compensation signal, the first interference compensation signal operable to suppress interference imposed on the first receiver by the signals transmitted by the first transmitter in response to being coupled to the receive path of the first receiver.

2. The communication system of claim 1, wherein the first interference compensation signal comprises an amplitude substantially the same as amplitude of the interference imposed on the first receiver and a phase shifted approximately 180 degrees with respect to the interference imposed on the first receiver.

3. The communication system of claim 1, wherein the first communication device comprises a wireless local area network (“WLAN”) and wherein the second communication device comprises a Bluetooth transceiver.

4. The communication system of claim 1, wherein the first communication device comprises a WiMAX transceiver and wherein the second communication device comprises a WLAN transceiver.

5. The communication system of claim 1, wherein the first communication device comprises a WiMAX transceiver and wherein the second communication device comprises a Bluetooth transceiver.

6. The communication system of claim 1, further comprising at least one of (a) a signal splitter, (b) a signal combiner, (c) a coupler, and (d) a circulator disposed between the first transmitter, the first receiver, and the antenna, wherein the interference imposed on the first receiver comprises signals leaked through the signal splitter, the signal combiner, the coupler, or the circulator.

7. The communication system of claim 1, wherein the first interference compensation circuit comprises a first noise canceling device and an amplifier coupled to an output of the first noise canceling device.

8. The communication system of claim 1, wherein the first communication device further comprises a power amplifier disposed between the first transmitter and the antenna and wherein the first input obtains the first samples from a signal path coupling an output of the power amplifier to the antenna.

9. The communication system of claim 1, wherein the first input comprises a first directional coupler and wherein the first output comprises a second directional coupler.

10. The communication system of claim 1, wherein the first communication device comprises a second receiver that receives signals comprising a frequency within the first frequency band via the antenna and wherein the second communication device comprises a second transmitter that transmits signals comprising a frequency within the second frequency band.

11. The communication system of claim 10, further comprising:
a second input for obtaining second samples of signals transmitted by the second transmitter;
a second output for coupling a second interference compensation signal to a receive path of the second receiver; and
a second interference compensation circuit, disposed between the second input and the second output, that adjusts at least one of amplitude, phase, and delay of the second samples to generate the second interference compensation signal based on a second in-phase parameter and a second quadrature parameter, the second interference compensation signal operable to suppress interference imposed on the second receiver by the signals transmitted by the second transmitter in response to being coupled to the receive path of the second receiver.

12. The communication system of claim 10, further comprising:
a second input for obtaining second samples of signals transmitted by the second transmitter;
a second output for coupling a second interference compensation signal to a receive path of the second receiver;
a first switching mechanism coupled to an input of the first interference compensation circuit that selectively switches between a first position wherein the input of the first interference compensation circuit receives the first samples and a second position wherein the input of the first compensation circuit receives the second samples;
a second switching mechanism coupled to an output of the first interference compensation circuit that selectively switches between a first position wherein the output of the first interference compensation circuit couples to the first output and a second position wherein the output of the first interference compensation circuit couples to the second output,
wherein the first interference compensation circuit is operable to adjust as least one of amplitude, phase, and delay of the second samples to generate the second interference compensation signal based on a second in-phase parameter and a second quadrature parameter, the second interference compensation signal operable to suppress interference imposed on the second receiver by the signals transmitted by the second transmitter in response to being coupled to the receive path of the second receiver.

13. The communication system of claim 1, further comprising a controller that adjusts at least one of the in-phase parameter and the quadrature parameter in response to at least one of: (a) an intensity level of the interference imposed on the first receiver by the signals transmitted by the first transmitter, (b) a bit error rate for the first receiver, (c) a packet error rate for the first receiver, (d) a signal to noise ratio for the first receiver, (e) a carrier to noise ratio for the first receiver, and (f) an error vector magnitude for the first receiver.

14. The communication system of claim 1, wherein the first communication device further comprises a second transmitter for transmitting signals comprising a frequency within the first frequency band via a second antenna.

15. The communication system of claim 14, further comprising:
a second input for obtaining second samples of the signals transmitted by the second transmitter; and
a second interference compensation circuit, disposed between the second input and the first output, that adjusts at least one of amplitude, phase, and delay of the second samples to generate a second interference compensation signal based on a second in-phase parameter and a second quadrature parameter, the second interference compensation signal operable to suppress interference imposed on the first receiver by the signals transmitted by the second transmitter in response to being coupled to the receive path of the first receiver.

16. The communication system of claim 14, further comprising:
a second input for obtaining second samples of the signals transmitted by the second transmitter;
a second output for coupling a second interference compensation signal to the receive path of the first receiver; and
a second interference compensation circuit, disposed between the second input and the second output, that adjusts at least one of amplitude, phase, and delay of the second samples to generate the second interference compensation signal based on a second in-phase parameter and a second quadrature parameter, the second interference compensation signal operable to suppress interference imposed on the first receiver by the signals transmitted by the second transmitter in response to being coupled to the receive path of the first receiver.

17. The communication system of claim 1, wherein the communication system is comprised in a cellular telephone.

18. A method for suppressing interference, comprising:
obtaining first samples of first signals transmitted by a first transmitter of a first communication device, the first signals comprising a frequency within a first frequency band, the first signals being obtained from a transmit signal path between the transmitter and an antenna;
generating a first interference compensation signal in response to adjusting at least one of amplitude, phase, and delay of the first samples based on an in-phase variable and a quadrature parameter;
applying the first interference compensation signal to a receive signal path of a first receiver of a second communication device, the first receiver operable to receive signals comprising a frequency within a second frequency band via the antenna, the second frequency band being adjacent or overlapping the first frequency band; and
in response to the first interference compensation signal being applied to the receive signal path of the first receiver, suppressing interference imposed on the first receiver by the signals transmitted by the first transmitter.

19. The method of claim 18, wherein the first interference compensation signal comprises an amplitude substantially the same as amplitude of the interference imposed on the first receiver and a phase shifted approximately 180 degrees with respect to the interference imposed on the first receiver.

20. The method of claim 18, wherein the first samples are obtained from an output of a power amplifier disposed between the first transmitter and the antenna.

21. The method of claim 18, further comprising:
receiving signals comprising a frequency within the first frequency band by a second receiver of the first communication device; and
transmitting signals comprising a frequency within the second frequency band by a second transmitter of the second communications device.

22. The method of claim 21, further comprising:
obtaining second samples of the signals transmitted by the second transmitter;
generating a second interference compensation signal in response to adjusting at least one of amplitude, phase, and delay of the second samples based on a second in-phase variable and a second quadrature parameter;
applying the second interference compensation signal to a receive signal path of the second receiver; and
in response to the second interference compensation signal being applied to the receive signal path of the second receiver, suppressing interference imposed on the second receiver by the signals transmitted by the second transmitter.

23. The method of claim 18, further comprising:
detecting an intensity level of the interference imposed on the first receiver by the signals transmitted by the first transmitter;
adjusting, by a controller, at least one of the in-phase variable and the quadrature variable of the first interference compensation circuit in response to the intensity level.

24. The method of claim 18, further comprising transmitting, by a second transmitter of the fist communication device, signals comprising a frequency within the first frequency band via a second antenna.

25. The method of claim 24, further comprising:
obtaining second samples of the signals transmitted by the second transmitter;
generating a second interference compensation signal in response to adjusting at least one of amplitude, phase, and delay of the second samples based on a second in-phase variable and a second quadrature parameter;
applying the second interference compensation signal to the receive signal path of the first receiver; and
in response to the second interference compensation signal being applied to the receive signal path of the first receiver, suppressing interference imposed on the first receiver by the signals transmitted by the second transmitter.

26. A communication system, comprising:
a first communication device comprising:
a first transmitter for transmitting signals comprising a frequency within a first frequency band via a first antenna;
a second transmitter for transmitting signals comprising a frequency within the first frequency band via a second antenna;
a second communication device comprising a first receiver for receiving signals comprising a frequency within a second frequency band via the first antenna, the second frequency band being adjacent or overlapping the first frequency band;
a first input for obtaining first samples of the signals transmitted by the first transmitter;
a first output for coupling a first interference compensation signal to a receive path of the first receiver;
a first interference compensation device, disposed between the first input and the first output, that adjusts at least one of amplitude, phase, and delay of the first samples to generate the first interference compensation signal based on an in-phase setting and a quadrature setting, the first interference compensation signal operable to suppress interference imposed on the first receiver by the signals transmitted by the first transmitter in response to being coupled to the receive path of the first receiver; and
a controller for executing one or more algorithms using a feedback value received from the first receiver to determine the in-phase setting and the quadrature setting.

27. The communication system of claim 26, wherein the first input comprises a sampling capacitor and wherein the first output comprises a coupling capacitor.

28. The communication system of claim 26, wherein the first interference compensation signal comprises an amplitude substantially the same as amplitude of the interference imposed on the first receiver and a phase shifted approximately 180 degrees with respect to the interference imposed on the first receiver.

29. The communication system of claim 26, wherein the first communication device comprises a multiple-input multiple-output (“MIMO”) wireless local area network (“WLAN”).

30. The communication system of claim 26, further comprising:
a second input for obtaining second samples of the signals transmitted by the second transmitter;
a second output for coupling a second interference compensation signal to the receive path of the first receiver; and
a second interference compensation device disposed between the second input and the second output, that adjusts at least one of amplitude, phase, and delay of the second samples to generate the second interference compensation signal based on a second in-phase setting and a second quadrature setting, the second interference compensation signal operable to suppress interference imposed on the first receiver by the signals transmitted by the second transmitter in response to being coupled to the receive path of the first receiver.

31. The communication system of claim 26, further comprising:
a second input for obtaining second samples of the signals transmitted by the second transmitter; and
a second interference compensation device, disposed between the second input and the first output, that adjusts at least one of amplitude, phase, and delay of the second samples to generate the second interference compensation signal based on a second in-phase setting and a second quadrature setting, the second interference compensation signal operable to suppress interference imposed on the first receiver by the signals transmitted by the second transmitter in response to being coupled to the receive path of the first receiver.

32. The communication system of claim 26, wherein the first communication device further comprises a second receiver for receiving signals comprising a frequency within a first frequency band via the first antenna.

33. The communication system of claim 32, further comprising a low noise amplifier disposed between the first antenna and (a) an input of the first receiver and (b) an input of the second receiver.

34. The communication system of claim 26, wherein the feedback value comprises one of Signal to Noise Ratio, a Receive Signal Strength Indicator, a Repeater Amplifier Gain, a Carrier to Noise Ratio, a Packet Error Rate, a Bit Error Rate, and an Error Vector Magnitude.

35. An isolation device for improving isolation between a first communication module and a second communication module that share an antenna, comprising:
a first input for obtaining first samples of first signals generated by the first communication module for transmission by the antenna;
a first output for coupling a first interference compensation signal to a receive path of the second communication module that receives second signals via the antenna; and
a first interference compensation circuit, disposed between the first input and the first output, that adjusts at least one of amplitude, phase, and delay of the first samples based on an in-phase parameter and a quadrature parameter to generate the first interference compensation signal, the first interference compensation signal operable to suppress interference imposed on the second communication module by the signals transmitted by the first communication module in response to being coupled to the receive path of the second communication module.

36. The isolation device of claim 35, further comprising:
a second input for obtaining second samples of third signals generated by the second communication module for transmission by the antenna;
a second output for coupling a second interference compensation signal to a receive path of the first communication module that receives fourth signals via the antenna; and
a second interference compensation circuit, disposed between the second input and the second output, that adjusts at least one of amplitude, phase, and delay of the second samples based on a second in-phase parameter and a second quadrature parameter to generate the second interference compensation signal, the second interference compensation signal operable to suppress interference imposed on the first communication module by the signals generated by the second communication module in response to being coupled to the receive path of the first communication module.

37. The isolation device of claim 35, wherein the isolation device is implemented in at least one integrated circuit.

38. A method for improving isolation between a first communication module and a second communication module that share an antenna, comprising:
obtaining a first portion of a first signal generated by the first communication module for transmission by the antenna; and
generating a first interference compensation signal by adjusting at least one of amplitude, phase, and delay of the first portion based on a first in-phase parameter and a first quadrature parameter; and
sending the first interference compensation signal towards a receive path of the second communication module,
wherein the first interference compensation signal is operable to suppress interference imposed on the second communication module by signals transmitted by the first communication module in response to being coupled to the receive path of the second communication module.

39. The method of claim 38, further comprising:
obtaining a second portion of a second signal generated by the second communication module for transmission by the antenna;
generating a second interference compensation signal by adjusting at least one of amplitude, phase, and delay of the second portion based on a second in-phase parameter and a second quadrature parameter; and
sending the second interference compensation signal towards a receive path of the first communication module,
wherein the second interference compensation signal is operable to suppress interference imposed on the first communication module by signals transmitted by the second communication module in response to being coupled to the receive path of the second communication module.
